(19) United States
(12) Patent Application Publication
(10) Pub. No.: US 2020/0051585 A1
(43) Pub. Date: Feb. 13, 2020

(54) VOICE ACTIVITY DETECTION METHOD AND APPARATUS

(71) Applicant: Babylon Partners Limited, London (GB)

(72) Inventors: Alessandro Rodolfo Guazzi, London (GB); Maxim Osipov, Oxfordshire (GB)

(21) Appl. No.: 16/342,514

(22) PCT Filed: Oct. 13, 2017
(86) PCT No.: PCT/GB2017/053099

§ 371 Date: Apr. 16, 2019

(30) Foreign Application Priority Data
Oct. 16, 2016 (GB) 1617544.0

(51) Int. Cl. G10L 25/84; G10L 15/22; G10L 25/18; G10L 25/21

(52) U.S. Cl. CPC G10L 25/84; G10L 15/22; G10L 2025/783; G10L 25/21; G10L 25/18

(57) ABSTRACT

A method and apparatus for detecting voice activity in an audio signal by taking the ratio of the entropy and the energy band ratio of the power spectrum of the audio signal. The signal is classified as containing voice episodes if the voice activity ratio is above a predefined threshold. The method may be applied to any noisy signal in which there is uncertainty about the presence of voice activity and in real-time analysis of sound, preceding further analysis of the sound signal.

### BACKGROUND

Methods to detect voice have seen growth, particularly for use in telecommunications. Conventional methods include calculating the loudness of the input signal and estimating periods of power above a given threshold as voice activity, or calculating the spectral flatness of the input signal and estimating periods of spectral flatness below a given threshold as period including voice activity. The problem with such methods is that they are prone to false measurements, misclassifying noise as speech, particularly in noisy environments in which there is intense background noise or in which the loudness of the voice is very low. In particular, using the spectral flatness of the signal alone is prone to misclassifying pure tones (such as whistling) and music as voice activity, and misclassifying multi-voice conversations as noise. This problem is particularly compounded in situations in which monitoring is continuous and extended over the course of several days, weeks, or months, and situations in which the microphone is in a variety of environments including, for example, when the microphone is in a pocket or a bag.

### TECHNICAL FIELD

The present invention relates to the detection of voice activity in a noisy setting, for example, to determine whether a human voice is present in an audio recording. In more detail, it relates to the analysis of audio signals to determine which sections of the audio signal contain episodes of human voice. Being able to detect episodes of human voice through audio analysis techniques is advantageous as it can allow further voice and speech analysis algorithms to work more accurately and with fewer resources.

### SUMMARY

Accordingly, the present invention provides a method of detecting and displaying episodes of human voice, comprising the steps of: acquiring one or more audio samples of an environment in which a human voice may be expected, estimating the power spectra of the audio signals, processing the power spectra to obtain an energy band ratio of the signal, processing the power spectra to obtain the spectral flatness, calculating the ratio of the spectral flatness and the energy band ratio, and setting a threshold above which the signal is classified as a voice activity segment.

The power spectrum may be, for example, calculated using standard spectral density estimation techniques such as the periodogram, by applying Welch's method or other periodogram estimation methods that estimate the power of a spectrum, or other spectral density estimation methods employing the Fourier Transform or the Fast Fourier Transform, or other spectral density estimation techniques that transform the audio signal in the time domain into a spectrum in the spectral domain.

Preferably, the input signal is pre-processed by standard signal-processing techniques prior to the spectral analysis step, for example, to reduce the well-reported effect of spectral leakage. As an example, the mean of the input digital signal may be subtracted from the signal and a Hamming window may be applied to the signal. Other windowing techniques may be used as best suit the application and the quality of the signal.

The spectral flatness may be, for example, the ratio of the geometric mean and arithmetic mean of the power spectrum, or another technique that estimates the degree of entropy in the signal (i.e. an entropy value). The spectral flatness may be evaluated over the whole spectrum or for part of it only, for example only in the range of interest for voice detection. For instance, the spectral flatness could be calculated only between 230 Hz and 2000 Hz. The formulation of the spectral flatness as a ratio of the geometric mean and the arithmetic mean can be shown to mathematically differentiate between Gaussian noise and structured spectra such as in speech and can be computed efficiently (unlike other methods of estimating spectral flatness).

The energy band ratio of the signal may be, for example, the ratio of, in the numerator a sum of a first plurality of segments of the power spectrum (energy bands), where each segment is divided by its frequency width, and in the denominator a sum of a second plurality of segments of the power spectrum, where each segment is also divided by its frequency width. The first and the second plurality of segments may be at least partially different to one another.

The frequency ranges of the segments may overlap and may be, for example, selected on the basis of the range of frequencies expected within the human voice for the numerator, and frequencies associated with noise for the denominator, or via a data-driven method, such as by evaluating the optimal frequency bands to be used by testing the response of the energy band ratio of the signal for different voices on different microphones. An example of the frequency ranges of segments determined by such a method would be, for instance, in the numerator segments of the power spectrum in the ranges 125-250 Hz, 250-500 Hz, 500-1000 Hz, and in the denominator segments of the power spectrum in the ranges 0-25 Hz, 25-125 Hz, 1000-2000 Hz, 2000-4000 Hz. Calculating the energy band ratio helps to reduce the detection of false positive instances of voice activity. For example, it can avoid music activity being detected as voice activity when used in conjunction with the spectral flatness estimation.

Preferably, the input audio signal is a digital audio signal and temporally windowed, the window length being based on the particular application, for example, based on the power requirements for the calculations and the real-time requirements of the application and the sampling frequency of the audio recording. For example, windows from 12 milliseconds to 120 milliseconds in duration may be used with sampling frequencies varying from 8000 Hz to 96000 Hz. If the input audio signal is not a digital signal, but analogue, standard analogue-to-digital components and processes can be used to transform the analogue signal into a digital signal.

The input signal may be an audio recording, or a digital signal produced by a microphone in real time. Examples of the latter are the signals may be obtained from microphones present on phones, headsets, computers, and smart-watches. Thus, the voice activity detection may be used in real-time to detect if a person is speaking while a microphone is recording.

Thus, the input signal can be a time series of sound data, and it can comprise of several channels from different microphones operating on a recording device. Preferably, if multiple microphones are present, each microphone is treated individually.

The invention may be embodied in a computer program comprising program code means for executing on a computer system the method steps. Alternatively, it can be embodied in firmware or hardware, or as program code for computing devices such as smartphones and wearables.

Another aspect of the invention provides an apparatus for analysing an input signal to detect the presence of human voice activity in the signal, the apparatus comprising an input for receiving the input signal, a processor for processing the input signal, wherein the processor is configured to execute the method described herein. The apparatus further includes an output to output the ratio or the signal detected, for example by means of a display. The apparatus further comprises memory (e.g. non-tangible memory) configured to store the computer program described herein. In one example, the method described herein is a computer-implemented method.

### BRIEF DESCRIPTION OF THE DRAWINGS

The invention will be further described by way of example with reference to the accompanying drawings in which:

FIG. 1 is a flow diagram that illustrates the method of one embodiment of the invention;

FIG. 2 shows the results of applying the embodiment of FIG. 1 to an intermittent day-long audio recording; and

FIG. 3 is a schematic illustrating the voice activity detection apparatus according to an embodiment of the invention.

### DETAILED DESCRIPTION

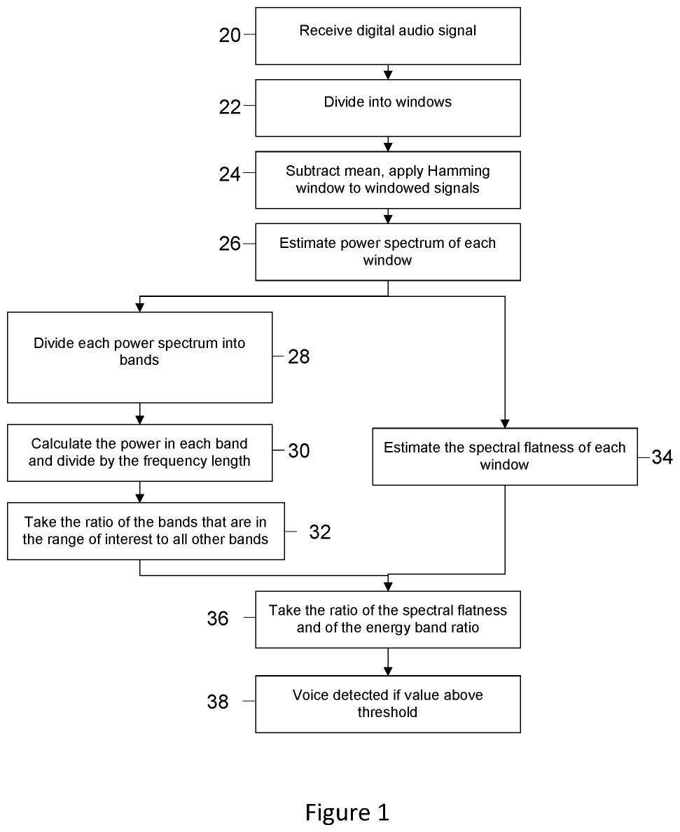

FIG. 1 is a flow diagram illustrating the application of an embodiment of the invention to the analysis of an audio signal derived from a smartphone microphone. In step 20, a digital audio signal from the microphone of a smartphone collects audio information of the environment around the microphone, for example at a sampling rate fₛ of 8000 Hz. In step 22, the signal is divided into non-overlapping windows of 512 samples each (64 ms long). Longer and shorter windows can be used and can be overlapping.

Steps 24 to 38 now refer to calculations carried out on each window rather than on the signal as a whole. In step 24, for each window the mean is subtracted from the signal to detrend it, and a Hamming window of the same size of the window is applied to the window to reduce spectral leakage in the spectral density estimation calculation of step 26. Any other windowing technique or windowing method may also be used, and the signal is typically already zero-centred so may not require a mean subtraction. In step 26, the power spectrum for the window in question is obtained for example by using a standard spectral analysis technique such as the Welch periodogram.

Steps 28 to 32 describe the calculation of the energy band ratio.

In step 28, the power spectrum is divided into energy bands, for example limited by frequency values of {0, 50, 250, 500, 1000, 2000, fs/2} Hz, or in other words the spectrum is divided into a plurality bands with each band having one of the following range of frequencies: 0-50 Hz, 50-250 Hz, 250-500 Hz, 500-1000 Hz, 1000-2000 Hz and 2000-4000 Hz for a sampling frequency (fs) of 8000 Hz. Other energy band ranges may also be used, including overlapping band ranges. For instance, a plurality of non-overlapping bands such as 0-25 Hz, 25-125 Hz, 125-250 Hz, 250-500 Hz, 500-1000 Hz and 1000-2000 Hz may be selected or a plurality of overlapping bands such as 0-50 Hz, 25-125 Hz, 125-350 Hz, 250-500 Hz, 400-1500 Hz and 1000-2000 Hz may be selected.

In step 30, the cumulative power within each energy band is calculated, and each energy band is normalised by the frequency range of each energy band respectively.

In step 32, the energy band ratio is found by calculating the ratio of the sum of the normalised cumulative power values for each energy band within a first frequency range, such as the expected frequency range for voice, against the sum of the normalised cumulative power values for each energy band within a second frequency range, such as energy bands associated with background noise. For example, the range of frequency bands in the numerator is 250-2000 Hz and the range of frequency bands in the denominator comprises the bands within the 0-250 Hz frequency range and the 2000-4000 Hz frequency range. In another example, the normalised cumulative power values in the range between 250 Hz and 2000Hz may be, for example, used as the numerator, although other values may be chosen. The range of frequencies used for the normalised cumulative power values in the denominator may be all of the frequencies present in the signal, or in other words the second frequency range may be between the lowest and the highest frequency in the signal.

In step 34, the spectral flatness of all or part of the power spectrum is estimated by dividing the geometric mean of the power spectrum by the arithmetic mean of the power spectrum. Other methods to estimate the spectral flatness may also be used. Step 34 may be run in parallel, prior to, or after steps 28 to 32.

In step 36, the voice activity ratio is taken as the ratio of the spectral flatness and the energy band ratio. For instance, the voice activity ratio may be calculated by dividing the spectral flatness by the energy band ratio. In another example, the voice activity ratio may be calculated by dividing the energy band ratio by the spectral flatness ratio. In both of these examples, a ratio is determined which is indicative of a relationship between the energy band ratio and the spectral flatness. Then in step 38, the detection of voice activity is made by comparing the voice activity ratio to a pre-defined threshold. In one example, the pre-defined threshold is a threshold chosen from a range of 50-10000. The threshold may change depending on the level of sensitivity and specificity desired for the application and the context of the user. The threshold may be set, for example, ahead of use for example by selecting the optimal threshold for use across different microphones and the optimal threshold for each individual microphone, depending on the hardware characteristics and pre-processing steps applied by the microphone. The threshold may also be set, for example, dynamically to optimise for the settings of the microphone and noise levels present.

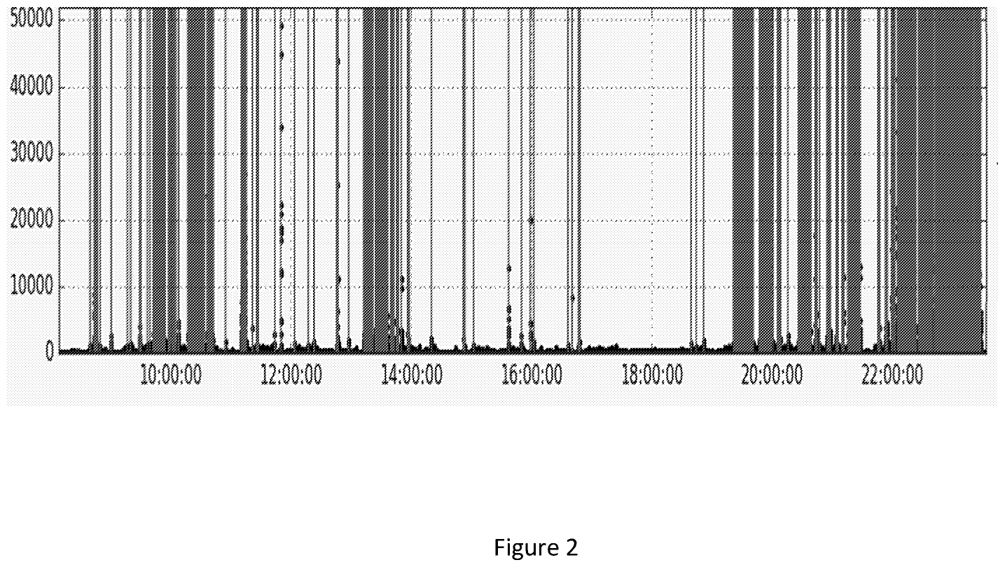

FIG. 2 shows the results of applying this example of the invention to a day-long (or 24-hour period) recording carried out using a smartphone. The dots indicate the values of the voice activity ratio. The lines indicate periods in which voice activity has been detected, using a threshold of 400. As can be seen, the invention is suitable for near-real-time analysis over long periods of time using relatively few resources.

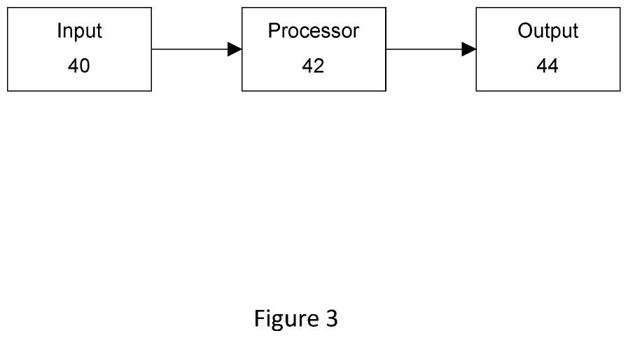

An embodiment of this invention may be a computer program for running on a computer system which receives the input audio data time series and estimates the result of the voice detection. The voice activity ratio may also be displayed. Alternatively, the invention may be incorporated into a dedicated apparatus, such as a monitor, which is shown as a schematic in FIG. 3. The apparatus comprises an input 40 for receiving the input data, a process 42 for executing the processing steps described above, and an output 44, for example a display, for outputting the detection of the voice or the voice activity ratio. Alternatively, the output may feed the windowed data for further processing into other methods, for example a speech method or person-identification method, or screen windowed data from being passed into the methods to avoid running them continuously.

The systems and methods described herein may be used to identify the frequency and duration of voiced and unvoiced segments in noisy contexts over extended periods of time.

One example includes monitoring the frequency and duration of voice episodes in association with a user over an extended period of time (for example of over a day), and if this frequency or duration is decreasing this can determine that the user is unsafe, unwell or socially withdrawn. In response, this determination may initiate a suggestion, such as activities, events, or meetings that can help improve the user's situation. The suggestion may be provided via an audio or visual alert generated via a device such as smartphone or tablet. This device may be the same device used to monitor voice activity.

Another example, may include monitoring the frequency and duration of voice episodes in association with a user, and if this frequency is low (or zero) determining that the user is unsafe and/or so as to measure loneliness or social isolation quantitatively.

Another example, may include monitoring the frequency or duration of voice episodes in association with the user to evaluate symptoms associated with a health condition, such as for example a mental health condition including depression or age related disorders and/or to evaluate a sociability score for the user.

Another example, may include the monitoring of the frequency and duration of unvoiced segments during a conversation, for example to detect or monitor anxiety or stress.

Another example, may include the monitoring of the frequency and duration of unvoiced segments during a conversation for example to detect or monitor health conditions such as for example a mental health condition.

In another example, voice activity is detected as a pre-processing step to the detection of speech through the analysis of the segments of signal identified as containing voice activity by the method.

In another example, voice activity is detected as a pre-processing step to the recognition of speech, for example the detection of the words being said or the language being used, through the analysis of the segments of signal identified as containing voice activity by the method.

In another example, voice activity is detected as a pre-processing step to the determination of the number of people speaking through the analysis of the segments of signal identified as containing voice activity by the method.

In another example, the method described herein is used as a pre-processing step to the identification of people speaking through the analysis of the segments of signal identified as containing voice activity by the method.

In another example, the method described herein is used as a pre-processing step to the detection of illnesses from the change in tone associated with voice through the analysis of the segments of signal identified as containing voice activity by the method.

In another example, the method described herein is used to identify audio segments identified by the method as containing human speech in an audio track or a recording, for example the audio track of a film.

In another example, the method described herein is used to identify the frequency and duration of voice activity in a particular location so as to determine how sociable the location is, as may be used for example by planners, architects or interior designers to design spaces.

The above-mentioned examples may be used in conjunction with the method described herein for detecting voice activity or with another method for detecting voice activity.

1. A method for detecting voice activity, the method comprising:
receiving an input signal;
estimating a power spectrum of the input signal;
calculating an energy band ratio of the input signal for a first set of equency ranges of the input signal to a second set of frequency ranges of the input signal;
calculating an entropy value of the input signal;
calculating a voice activity ratio based on the entropy value and the energy band ratio;
outputting an output signal indicating that the input signal comprises a voice episode, if the voice activity ratio is above a predefined threshold.

2. The method according to claim 1 wherein the input signal is a digital audio sample.

3. The method according to claim 1 wherein the power spectrum is calculated by estimating a periodogram of the input signal in the time domain.

4. The method according to claim 1 wherein the input signal is pre-processed before estimating the power spectrum, by detrending the input signal and applying a windowing function to the input signal.

5. The method according to claim 1 wherein calculating an entropy value of the signal comprises calculating a spectral flatness of the signal.

6. The method according to claim 5 wherein the spectral flatness is calculated by calculating a geometric mean of the power spectrum and an arithmetic mean of the power spectrum and dividing the geometric mean of the power spectrum by the arithmetic mean of the power spectrum.

7. The method according to claim 1 wherein calculating the energy band ratio comprises calculating a ratio of the first frequency range of the input signal to the second frequency range in the signal.

8. The method according to claim 1 wherein the second frequency range is between the lowest and the highest frequency in the signal.

9. The method according to claim 1 wherein the first frequency range is a range of frequencies expected within human voice.

10. The method according to claim 1 wherein the first frequency range is between 250 Hz and 2000 Hz.

11. The method according to claim 1 wherein the second frequency range is a range of frequencies associated with background noise.

12. The method according to claim 1 wherein the second frequency range is 0-250 Hz and 2000-4000 Hz,

13. The method according to claim 1 wherein the energy band ratio is calculated using a ratio of energy bands between 250 Hz and 2000 Hz against all other energy bands in the input signal.

14. The method according to claim 1 wherein the spectrum is divided into bands of 0-50 Hz, 50-250 Hz, 250-500 Hz, 500-1000 Hz, 1000-2000 Hz and 2000-fs Hz; or
bands of 0-25 Hz, 25-125 Hz, 125-250 Hz, 250-500 Hz, 500-1000 Hz and 1000-2000 Hz; or
bands of 0-50 Hz, 25-125 Hz, 125-350 Hz, 250-500 Hz, 400-1500 Hz and 1000-2000 Hz.

15. The method according to claim 1 wherein the predetermined threshold is determined based on a desired sensitivity and/or specificity.

16. The method according to claim 1 wherein the determined threshold is in a range between 50 and 10000.

17. The method according to claim wherein the input signal is temporally windowed and the method is performed for each window.

18. The method according to claim 1, wherein the input signal is divided into windows, of preferably 12 to 120 milliseconds in duration, and the method is performed for each window.

19. The method according to claim 17 wherein the windows are overlapping windows.

20. The method according to claim 18 wherein the windows are overlapping windows.

21. The method according to claim 20 wherein the overlap between adjacent windows is between 1 and 110 milliseconds in duration.

22. The method according to claim 1, wherein the input signal is a time series of digital audio data from an audio recording device.

23. The method according to claim 1, wherein the input signal is an analogue audio data time series that is discretised and converted into a digital audio time series prior to performing the method.

24. An apparatus for detecting voice activity, the apparatus comprising;
an input for receiving an input signal;
a processor for processing the input signal;
the processor being configured to execute a method for detecting voice activity. the method comprising:
receiving an input signal;
estimating a power spectrum of the input signal;
calculating an energy band ratio of the input signal for a first set of frequency ranges of the input signal to a second set of frequency ranges of the input signal;
calculating an entropy value of the input signal:
calculating a voice activity ratio based on the entropy value and the energy band ratio; and
outputting an output signal indicating that the input signal comprises a voice episode, if the voice activity ratio is above a predefined threshold.

25. (canceled)

26. The apparatus of claim 24 further comprising an output configured to output the output signal or the voice activity ratio.

27. The Apparatus according to claim 26 wherein the output is configured to output the result of the detection or the processed input signal itself to continue analysis if a necessary condition is met.

28-30. (canceled)

31. A non-transitory computer readable storage medium is provided including instructions that, when executed by a processor, cause the processor to perform a method for detecting voice activity, the method comprising:
receiving an input signal;
estimating a power spectrum of the input signal;
calculating an energy band ratio of the input signal for a first set of frequency ranges of the input signal to a second set of frequency ranges of the input signal;
calculating an entropy value of the input signal;
calculating a voice activity ratio based on the entropy value and the energy band ratio; and
outputting an output signal indicating that the input signal comprises a voice episode, if the voice activity ratio is above a predefined threshold.
